(19) United States
(12) Patent Application Publication
(10) Pub. No.: US 2005/0110615 A1
(43) Pub. Date: May 26, 2005

(54) Radio communications medium processing unit

(75) Inventors: Futoshi Deguchi, Fukuoka-shi (JP); Yoshitaka Mizoguchi, Fukuoka-shi (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 10/991,946

(22) Filed: Nov. 19, 2004

(30) Foreign Application Priority Data
Nov. 21, 2003 (JP) 2003-392237

(51) Int. Cl. H04Q 5/22

(52) U.S. Cl. 340/10.51; 455/106

(57) ABSTRACT

Providing a radio communications medium processing unit which suppresses variations in potential at the grounding end and variations in ground potential used for signal processing, thereby performing accurate signal processing. The invention comprises an antenna, a read/write section for reading or writing data, or reading and writing data from/to a radio communications medium via the antenna, a conductive line having an electric distance below the quarter wavelength of a frequency in use, the conductive line connected to the extremity of at least one grounding end present on the read/write section and the antenna, and a variable lumped constant unit for changing the lumped constant of the impedance connected at some midpoint in the conductive line, characterized in that the extremity of the conductive line is an open end.

### BACKGROUND OF THE INVENTION

1. Field of the Invention

The present invention has as an object to provide a radio communications medium processing unit which supplies power and transmit data to a radio communications medium such as a non-contact IC card and an IC tag housed in a shelf, a box or a cage and acquires receive data from the radio communications medium by way of variations in load and which is preferably used for a storage shelf automatically enabling commodity management.

2. Description of the Related Art

Recently, there have been used more radio communications media having an ID code such as and IC card and an IC tag as well as more radio communications medium processing units which performs IC code authentication of the radio communications medium for authentication and sorting by destination. When a radio communications medium is present within the service range of a radio communications medium processing unit, an induced voltage is generated on an antenna of the radio communications medium by way of an electromagnetic wave from an antenna and the voltage is rectified and power and transmit data are supplied. On the radio communications medium where power is supplied, for example in a modulating circuit comprising a load resistance connected to an antenna and a switch, the switch is turned on/off in accordance with 1s and 0s of data read from a mounted memory. The on/off processing generates variations in a load on the antenna of the radio communications medium and the variations in load are transmitted to the antenna of the radio communications medium processing unit. A signal transmitted is demodulated and its ID code authentication is carried out (for example, refer to Japanese Patent Laid-Open No. 2000-163523).

On a related art radio communications medium processing unit, there has been a problem that variations in electric potential at the grounding end provided in any area of the radio communications medium processing unit easily take place, which causes variations in ground potential as a reference in the processing unit, thereby inviting malfunction of the processing unit and read error.

The grounding end must be essentially at a ground potential. Variations in potential of the grounding end by several volts causes 1s of data to be erroneously determined as 0s or 0s to be erroneously determined as 1s in demodulation in the read/write section using the ground potential as a reference.

In case the length of a conductor present at and beyond the grounding end is substantially different from a wavelength having the quarter wavelength of a frequency in use, the potential reaches its maximum at the extremity of the conductor. Thus, the potential varies accordingly at the grounding end where the potential should be 0 volts. The ground potential is greatly subject to variations in potential at the grounding end. This readily causes variations in ground potential.

This is specifically problematic in low frequencies where wavelength is longer and especially noticeable at a frequency of 13.56 MHz specified by the standard for a radio communications medium processing unit using an IC card. This problem occurs irrespective of in which area the grounding end is located, for example, connected to an antenna.

### SUMMARY OF THE INVENTION

In view of the aforementioned problems, the invention has as an object to provide a radio communications medium processing unit which prevents variations in potential at the grounding end provided on the radio communications medium processing unit and which prevents malfunction of the unit as well as determination error in demodulation.

The invention provides a radio communications medium processing unit comprising an antenna, a read/write section for reading or writing data, or reading and writing data from/to a radio communications medium via the antenna, and potential variation absorption means for absorbing variations in potential at the grounding end of the read/write section. With this configuration, it is possible to perform signal processing while absorbing the variations in ground potential used as a reference potential of signal processing, which remarkably reduces determination errors.

The invention provides a radio communications medium processing unit comprising an antenna, a read/write section for reading or writing data, or reading and writing data from/to a radio communications medium via the antenna, a conductive line having an electric distance below the quarter wavelength of the frequency in use, the conductive line connected to the extremity of at least one grounding end present in the read/write section or on the antenna, and a variable lumped constant unit for changing the lumped constant of the impedance connected at some midpoint in the conductive line, characterized in that the extremity of the conductive line is an open end. With this configuration, the electric distance from the grounding end to the open end is set to the quarter wavelength of the frequency in use by employing a shorter, more compact circuit element. This suppresses variations in ground potential and improves the signal processing accuracy as well as downsizing the unit.

### BRIEF DESCRIPTION OF THE DRAWINGS

FIG. 1 is a block diagram of a radio communications medium processing unit according to Embodiment 1 of the invention;

FIG. 2 is a block diagram of varying potential signal processing means according to Embodiment 1 of the invention;

FIG. 3 is another block diagram of the varying potential signal processing means according to Embodiment 1 of the invention;

FIG. 4 is another block diagram of the radio communications medium processing unit according to Embodiment 1 of the invention;

FIG. 5 is another block diagram of the radio communications medium processing unit according to Embodiment 1 of the invention;

FIG. 6 is a block diagram of a radio communications medium processing unit according to Embodiment 2 of the invention;

FIG. 7 is another block diagram of the radio communications medium processing unit according to Embodiment 2 of the invention;

FIG. 8 is a block diagram of a variable lumped constant unit according to Embodiment 2 of the invention;

FIG. 9 is another block diagram of the radio communications medium processing unit according to Embodiment 2 of the invention;

FIG. 10 is a block diagram of a current measurement section according to Embodiment 2 of the invention;

FIG. 11 is another block diagram of the radio communications medium processing unit according to Embodiment 2 of the invention;

FIG. 11(b) is another block diagram of the radio communications medium processing unit according to Embodiment 2 of the invention;

FIG. 11(c) is another block diagram of the radio communications medium processing unit according to Embodiment 2 of the invention;

FIG. 12 is another block diagram of the radio communications medium processing unit according to Embodiment 2 of the invention;

FIG. 13 is a block diagram of a radio communications medium processing unit according to Embodiment 3 of the invention; and

FIG. 14 is another block diagram of the radio communications medium processing unit according to Embodiment 3 of the invention.

### DESCRIPTION OF THE PREFERED EMBODIMENTS

Embodiments of the invention are described below referring to the drawings.

Radio communications media in this invention include media capable of communicating with a processing unit in a non-contact fashion, such as a non-contact IC card, an IC tag, an ID tag, an identification label, and an RF-ID tag. The processing unit is a unit communicating such a radio communications medium and is a so-called writer, reader/writer, or a read/write unit.

### Embodiment 1

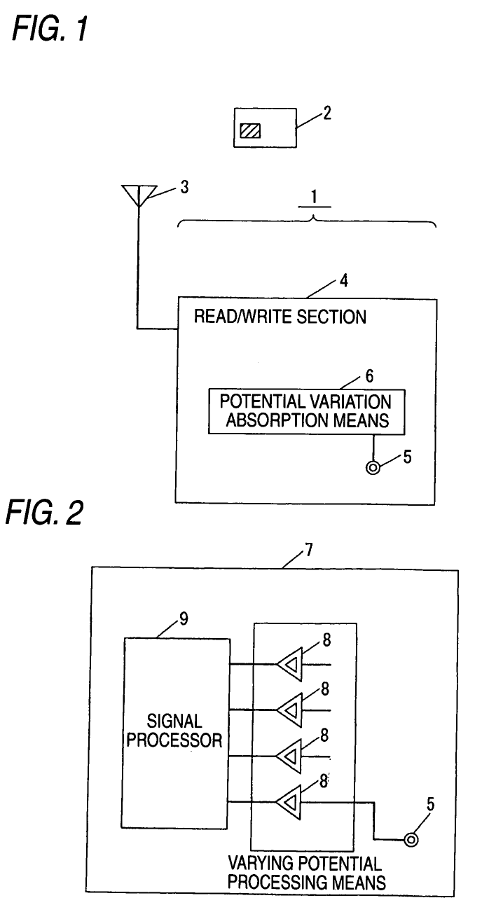

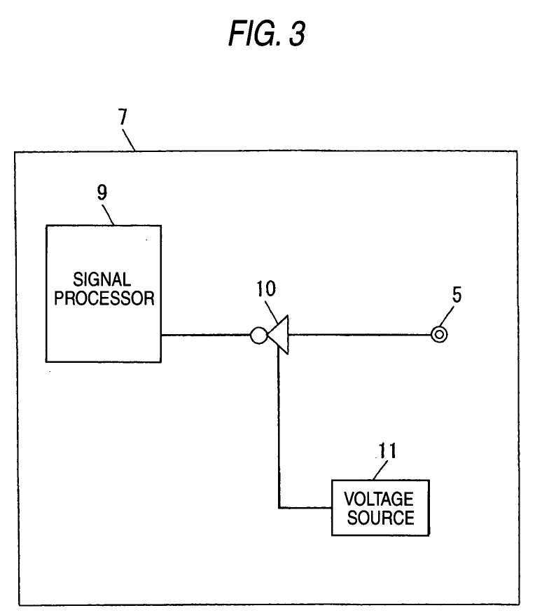

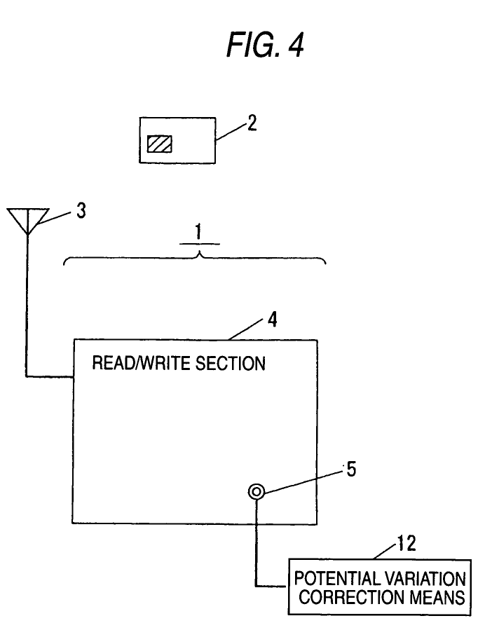

FIGS. 1, 4 and 5 are block diagrams of a radio communications medium processing unit according to Embodiment 1 of the invention. FIGS. 2 and 3 are block diagrams of varying potential signal processing means according to Embodiment 1 of the invention.

A numeral 1 represents a radio communications medium processing unit, 2 a radio communications medium, 3 an antenna, 4 a read/write section, 5 a grounding end, 6 potential variation absorption means, 7 varying potential signal processing means, 8 a Schmitt element, 9 a signal processor, 10 a conditional reversal element, 11 a voltage source, 12 potential variation correction means, 13 a variable lumped constant unit, and 14 a conductive line.

The radio communications medium 2 is a medium capable of communicating in a non-contact fashion, such as a non-contact IC card, an IC tag, an ID tag, an identification label, and an RF-ID. Inside the radio communications medium 2 are typically included a memory and an antenna. Any other configuration is possible.

The radio communications medium processing unit 1 is a processing unit for communicating with the radio communications medium 2 and is a reader for only reading data from the radio communications medium 2, a writer for only writing data to the radio communications medium 2, or a reader/writer for performing both operations. Operation of the radio communications medium processing unit 1 is described below. A necessary signal current is supplied from the read/write section 4 to the antenna 3. The supplied signal current is generated as a magnetic field from the antenna 3. This causes an induced electromotive force on the antenna built into the radio communications medium 2. This supplies power and signal data to the IC built into the radio communications medium 2. In the radio communications medium where power is supplied, a variation in the load is generated in a modulation circuit including a switch and a load circuit in accordance with the data from the mounted memory. The variation in the load is transmitted to the antenna 3 by way of mutual inductance. The antenna 3 receives the variation in the load as a signal, which is transmitted as a received signal to the read/write/section 4. The read/write/section 4 demodulates the signal and performs error detection as required in order to analyze the signal from the radio communications medium.

The antenna 3 communicates with the radio communications medium 2. The antenna applies a magnetic field on the radio communications medium to supply data and power. The antenna 3 is provided in a variety of shapes: a loop antenna for efficiently generating a magnetic field; a loop antenna formed by a three-dimensional curve for applying a magnetic field in the three-dimensional space, and a plane antenna. An electric field shielding to attenuate the distant electric field generated from the antenna 3 is preferably provided. Or, a magnetic plate to prevent an increase in the loss caused by an eddy current on a metal on the periphery of the antenna is preferably arranged around the antenna 3.

The read/write section 4 performs signal processing, that is, modulates data to be written into the radio communications medium 2 and demodulates received data from the radio communications medium 2. The read/write section 4 also forms a data stream, reproduces demodulated data, and performs error detection, error correction and determination, as required. Such signal processing may be made by way of a combination of discrete elements. All or some of the elements are packed into an integrated circuit thereby attaining unit downsizing. Or, a microprocessor is preferably used to processing part or all of signal processing based on software. In the signal processing, a ground potential which is typically 0 volts and the power supply potential as the maximum potential are used as reference potentials in order to determine the voltage of a signal by using “1” and “0” for demodulation of digital data. In case the ground potential is 0 volts and the maximum potential is 5 volts in the signal processing, a signal having a higher voltage than a threshold of 2.5 volts is determined as 1 and otherwise 0. The ground potential reflects the potential of the grounding end 5. Thus, a variation in the potential of the radio communications medium 5 could cause determination errors.

The grounding end 5 is connected to a ground potential and is provided in any area of the read/write section 4 or any area of the antenna 3. The ground potential which is ideally 0 volts is supplied to the unit or antenna 3. The grounding end 5 may be singular or may be multiple.

The potential variation absorption means. 6 absorbs variations in potential at the grounding end. The potential variation absorption means 6 may use a method for correcting the variations in potential at the grounding end 5 into an essentially required ground potential, or a method of executing signal processing in the read/write section 4. The potential variation absorption means 6 may use either of these methods as required or selectively use either of them.

Typically, a pattern on a substrate is connected to the grounding end 5. At the extremity of the pattern, the impedance or potential is the maximum. The value of potential is determined by the amplitude of a wavelength corresponding to the frequency in use. Thus, the potential at the grounding end 5 is determined by the wavelength of a signal used and an electric distance of a conductive line 14 present beyond the grounding end 5. For example, in case the electric distance is much shorter than the quarter wavelength of a signal used, great variations in signal, amplitude at the grounding end 5 results in great variations in potential at the grounding end 5. In case the electric distance is equal to the quarter wavelength of a signal used, a peak of amplitude is present at the extremity so that an amplitude node is present at the grounding end 5, thus variations in potential are negligible. In this case, an extremely low frequency of about 13.56 MHz may be used for an RF-ID using an IC card. In this practice, the quarter wavelength of a frequency in use is as long as about 5.5 m. It is not practical to provide such a long electric distance at the extremity of the grounding end 5 by way of a substrate pattern. When a substrate pattern is enlarged, the resulting unit size grows, which hampers compact design required of a radio communications medium processing unit.

Thus, as potential variation absorption means, varying potential signal processing means for performing signal processing based on the varied potential is used for signal processing, or potential variation correction means for correcting a varied potential is used to solve the problems.

A case will be described where the varying potential signal processing means is used.

FIG. 2 shows varying potential signal processing means. The varying potential signal processing means has a Schmitt element 8 at the signal input section of the signal processor 9.

The Schmitt element 8 determines the voltage level of a signal while using a threshold having a value range. The signal processor 9 performs signal modulation/demodulation and data reproduction. The output of the Schmitt element 8 is used by the signal processor 9 to perform signal processing. The Schmitt element 8 has a threshold which has a range of values. Thus, the Schmitt element 8 determines the voltage level as 1 or 0 excluding an arbitrary central range, unlike general practice where the voltage level of a signal having a range of 0 to 5 volts is determined as 1 (high) or 0 (low) by using the central value of 2.5 volts as a boundary. For example, the Schmitt element 8 determines 0 to 1.5 volts as 0 while 3.5 to 5 volts as 1. As a result, even in case the ground potential as a reference potential for signal processing has varied at the grounding end 5, determination errors can be reduced where a voltage level otherwise determined as 0 or 1 is determined as 1 or 0, respectively.

FIG. 3 shows a case where the conditional reversal element 10 is used as varying potential signal processing means.

The conditional reversal element 10 uses, as its conditional signal, an arbitrary voltage value as an output of the voltage source 11. To the input of the conditional reversal element 10 is connected the output of the grounding end 5. The output of the conditional reversal element 10 is used as a ground potential at the signal processor 9.

An arbitrary voltage value from the voltage source 11 is input to the condition of the conditional reversal element 10. In case the voltage value output from the grounding end 5 as an input is lower than the arbitrary voltage value, the voltage value is output without being reversed. In case the voltage value output from the grounding end 5 as an input is higher than the arbitrary voltage value, the voltage value is reversed before it is output. The output of the grounding end 5 should essentially be a ground potential which is 0 volts but may have a much higher voltage value due to variations. In this case, using the high voltage as a ground potential which serves as a reference potential for signal processing in the signal processor 9 will result in a signal determination error. As shown in FIG. 3, the conditional reversal element 10 is introduced to output the reversed voltage value in case the voltage value output from the grounding end 5 s higher than the arbitrary voltage value. Thus the obtained voltage value as an absolute value is small and it is used as a ground potential, which remarkably reduces determination errors.

The following describes a case where data processing of a signal is made in the signal processor 9 by comparing the ground potential with a signal while the voltage range is 0 to 5 volts.

In case a voltage value of 3 volts is input as a ground potential to the signal processor 9 due to variations in potential at the grounding end 5, assuming the voltage of the target signal is 2.8 volts, the voltage level is determined as 0 although the voltage level should be determined as 1 when a central value of 2.5 volts is used as a threshold.

In case the arbitrary voltage value of the voltage source 11 is 2.5 volts, the voltage value output from the grounding end 5 is reversed by the conditional reversal element. In fact, a value of 2 volts obtained by reversal of 3 volts is input to the signal processor 9. When the voltage of the target signal is 2.8 volts, the determination is 1, which is not a determination error. Thus, an arbitrary voltage value used as an output of the voltage source 11 is preferably a value close to a threshold value for signal determination used by the signal processor 9.

In this way, it is possible to perform error-free signal processing by using the conditional reversal element 10 as varying potential signal processing means 7 and absorbing variations in potential at the grounding end 5.

Next, a case will be described where potential variation correction means is used.

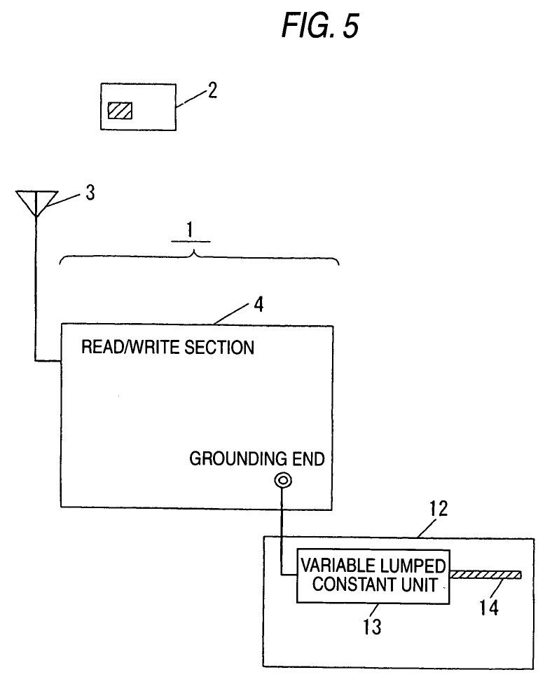

FIG. 4 shows a case where the potential variation correction means 12 is connected to the grounding end 5.

The potential variation correction means 12 is connected to the grounding end 5 and corrects the potential of the grounding end 5 which has varied to a ground potential which is zero volts. While the potential variation correction means 12 is externally connected to the read/write section 4 in FIG. 4, the potential variation correction means 12 may be housed therein.

The potential variation correction means 12 corrects the potential of the grounding end 5 to a ground potential of zero volts. A signal input from the grounding end 5 to the read/write section 4 is used as a ground potential serving as a reference potential for signal processing. The reference potential for signal processing is not subject to variations, thereby allowing correct signal determination and high-accuracy signal processing.

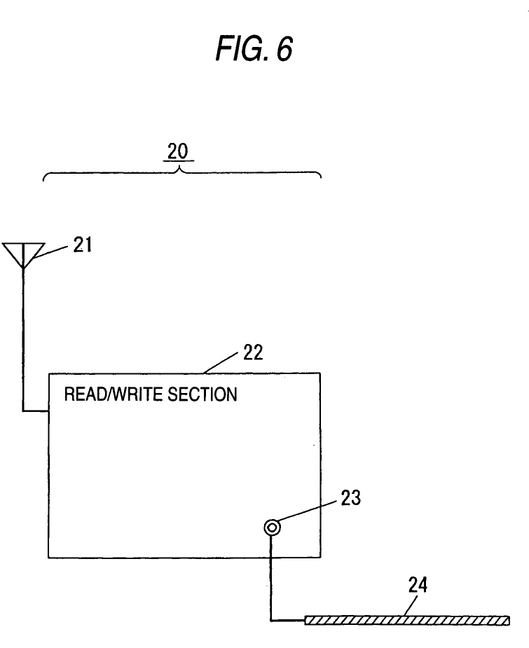

FIG. 5 shows a case where the variable lump constant unit 13 and the conductive line 14 are used as the potential variation correction means 12.

The variable lumped constant unit 13 provides the variable impedance as a lumped constant. It is thus possible to adjust the electric distance at the extremity of the grounding end 5 formed together with the conductive line 14 connected to the extremity of the grounding end 5. The conductive line 14 is a conductive line having a length shorter than the quarter wavelength of a signal in use and its extremity is an open end. In case the electric distance between the conductive line 14 and the grounding end 5 is equal to the quarter wavelength of a signal in use, the amplitude of a signal waveform at the grounding end 5 is substantially zero. Thus the variations in potential at the grounding end 5 are negligible and variations in ground potential used for signal processing are also negligible. Absence of variations in ground potential remarkably reduces signal determination errors in signal processing, thereby implementing the high-accuracy radio communications medium processing unit 1. The variable lumped constant unit 13 can handle a variable lumped constant so that flexible support for variations in frequency in use is assured.

While the potential variation correction means 12 comprises a combination of the conductive line 14 and the variable lumped constant unit 13 in FIG. 5, the potential variation correction means 12 may comprise only the conductive line 14 corresponding to the quarter wavelength of a signal in use. In this case, flexible support for variations in frequency is more difficult, with a tradeoff that a very simple arrangement is possible. Introduction of a flexible conductive line 14 to bend or wind the conductive line 14 will reduce the necessary volume, which adds to a more compact unit design.

With the aforementioned configuration, it is possible to perform signal processing while considering variations in potential at the grounding end 5 and absorb variations in potential to perform signal processing based on a ground potential free from variations in potential, thereby implementing the high-accuracy radio communications medium processing unit.

While the foregoing description refers to the radio communications medium processing unit as a unit, a radio communications medium processing method as a method is also envisaged.

Similar processing will give the same effect, such as performing all or part of processing by way of software.

For example, radio communications using an electromagnetic wave or optical communications using light is employed to communicate with a radio communications medium and write data to/from the radio communications medium. Signal processing of data read from the radio communications medium uses as a reference potential the ground potential supplied from the grounding end. In case the ground potential as a reference potential has varied, signal processing is performed based on the variations in ground potential to reduce determination errors. This is implemented by allowing for a wide threshold range in the determination of signal voltage level 1 or 0, or by reversing the potential in case the ground potential is higher than the central value of the voltage range used.

Alternatively, the above approach is implemented by suppressing variations in ground potential. For example, by adjusting the electric distance from the grounding end to the open end so that the distance will be equal to the quarter wavelength of a signal in use, it is possible to reduce the potential of the grounding end to one which is ideally 0 volts. In this case, by adjusting, proactively or reactively, the impedance from the conductive line and the lumped constant, the quarter wavelength of a signal in use is obtained. The ground potential used for signal processing is thus made stable around 0 volts, which eliminates determination errors in signal processing. Impedance adjustment is made by providing a variable conductive line or a variable lumped constant. As mentioned hereinabove, the high-accuracy radio communications medium processing is secured by way of signal processing which absorbs variations in potential or which is based on the variations, according to the inventive radio communications medium processing.

### Embodiment 2

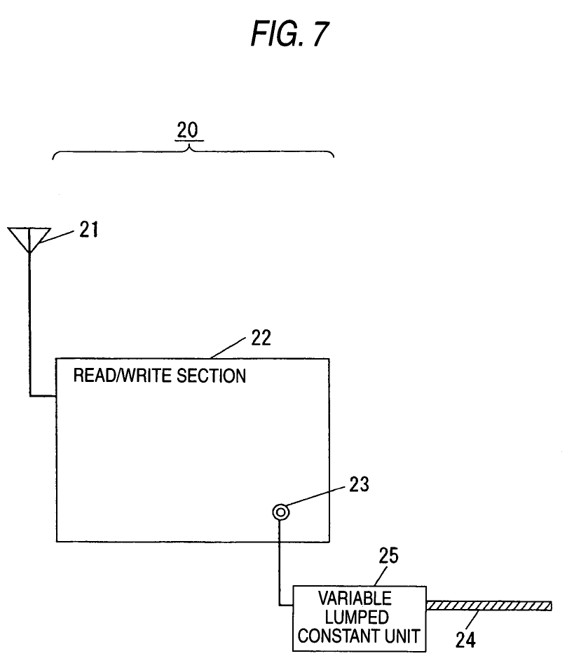

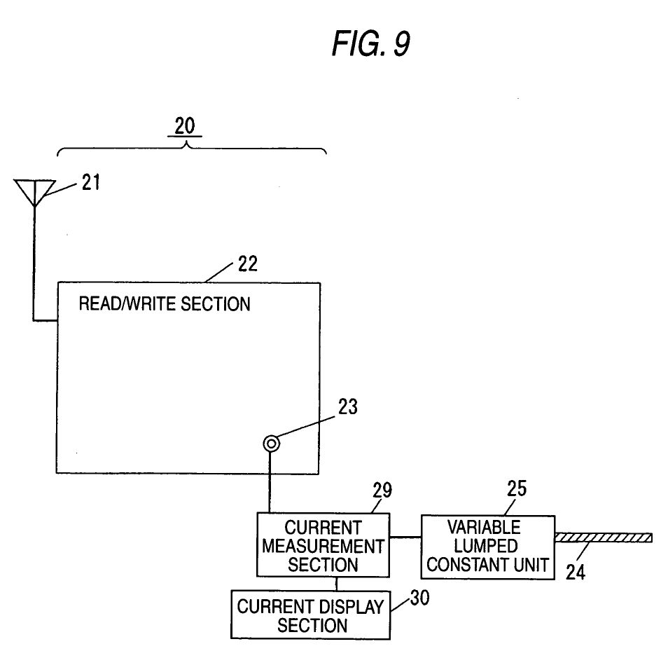

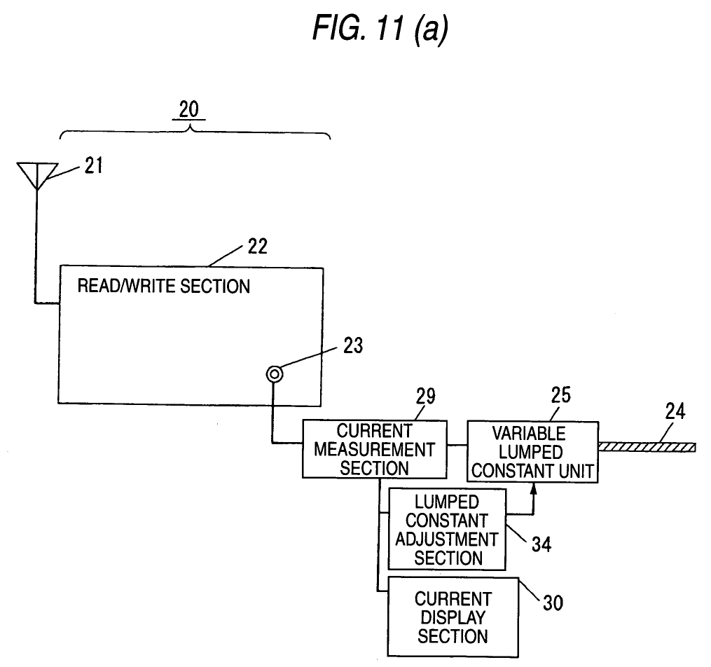

FIGS. 6, 7, 9, 11 and 12 are block diagrams of a radio communications medium processing unit according to Embodiment 2 of the invention. FIG. 8 is a block diagram of a variable lumped constant unit according to Embodiment 2 of the invention. FIG. 10 is a block diagram of a current measurement section according to Embodiment 2 of the invention.

A numeral 20 represents a radio communications medium processing unit, 21 an antenna, 11 a read/write section, 23 a grounding end, 24 a conductive line, 25 a variable lumped constant unit, 26 a grounding end, 27 a variable inductance, 28 a variable capacitance, 29 a current measurement section, 30 a current display section, 31 a loop conductor, 32 a resistor, 33 a diode, and 34 a lumped constant adjustment section.

FIG. 6 shows a radio communications medium processing unit 20 to which is connected a conductive line 24 having an electric distance of the quarter wavelength of a frequency in use at the extremity of the grounding end. As mentioned with respect to Embodiment 1, the impedance is the maximum, that is, the voltage is the maximum at the open end as the extremity of the grounding end 23. The wavelength of a signal peaked by the maximum point causes variations in potential at the grounding end 23. The variations in potential is transmitted to the read/write section 22 and the antenna 21, which causes variations in ground potential as a reference potential in the internal signal processing, resulting in signal determination errors.

Thus, the conductive line 24 having an electric distance equal to the quarter wavelength of a signal in use is connected to the extremity of the grounding end 23 and the extremity is formed into an open end. This provides the maximum impedance or voltage at the extremity and the minimum impedance or voltage at the grounding end 23 which is closer by the quarter wavelength. Thus variations in potential are suppressed. The ground potential which is essentially 0 volts is supplied to the read/write section 22 and the antenna 21 without being hampered. This remarkably reduces determination errors in signal processing and provides a high-accuracy radio communications medium processing unit 20.

A material of a high dielectric constant is preferably used to shorten the physical length of a conductive line. A flexible material is preferably used for the conductive line to bend or wind the conductive line in order to promote downsizing of the unit. The conductive line is preferably installed under the floor depending on the form of the installation location of the unit.

A joint used to divide or extend the conductive line 24 is preferably provided in order to support variations in frequency in use. A combination of parts of arbitrary lengths is preferably used to form the conductive line 24 in order to readily change the electric distance. This allows the frequency in use by the radio communications medium processing unit 20 to be changed flexibly in order to suppress variations in potential at the grounding end 23.

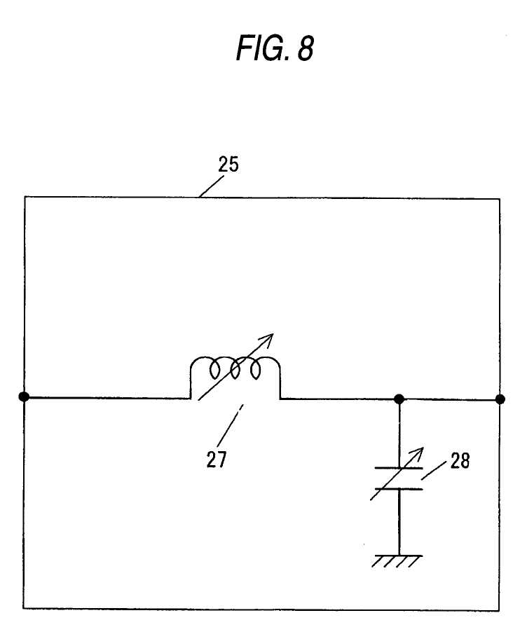

FIG. 7 shows a case where a combination of the variable lumped constant unit 25 and the conductive line 24 is used to reduce variations in potential at the grounding end 23.

The variable lumped constant unit 25 is connected to the extremity of the grounding end 23 and the conductive line 24 is connected thereto. The extremity of the conductive line 24 is an open end. The conductive line 24 has an electric distance below the quarter wavelength of a signal in use, unlike the case shown in FIG. 6. The extremity of the conductive line 24 is an open end so that the impedance or voltage is the maximum at the extremity. The variable lumped constant unit 25 has a feature to adjust the impedance as a lumped constant. By adjusting the impedance, it is possible to adjust the electric distance from the grounding end 23 to the open end at the extremity of the conductive line 24. That is, to form an electric distance of the quarter wavelength by using the conductive line 24 alone, the impedance mainly caused by the resistance component of the conductive line must be used, so that the resulting line length is often great. To offset this disadvantage, the impedance using a lumped constant is employed to shorten the physical length to secure the same electric distance.

The variable lumped constant unit 25 can vary the lumped constant so that it can readily adjust the electric distance as a sum of the electric distance of the conductive line 24 and the impedance where a lumped constant take place. It is thus possible to set the electric distance from the grounding end 23 to the open end to the quarter wavelength of the signal in use. This suppresses variations in potential at the grounding end 23 and allows the ground potential whose potential is ideally 0 volts to be supplied into the unit. The ground potential as a reference potential used by the read/write section 22 and the antenna 21 stays constant, which remarkably reduces determination errors in signal determination. For example, in case a signal whose voltage value is in the range of 0 to 5 volts is, determined as 1 when the voltage value is equal to or greater than 2.5 volts as a midpoint and as 0 when the voltage value is smaller than 2.5 volts, the reference ground potential is subject to negligible variations near 0 volts. This remarkably reduces opposite determination and accordingly determination errors. As a result, the accuracy of the radio communications medium processing unit 20 is greatly enhanced.

The conductive line 24 and the variable lumped constant unit 25 may be externally connected to the radio communications medium processing unit or may be housed in the same enclosure as the read/write section 22. In case the conductive line 24 and the variable lumped constant unit 25 are housed in the same enclosure, transportation, distribution and installation of the radio communications medium processing unit is made simpler.

FIG. 8 shows an example of the internal configuration of the variable lumped constant unit 25.

As a variable lumped constant unit 25, a circuit where a variable inductance 27 and a variable capacitance 28 are connected in parallel is used. Assuming that the inductor value of the variable inductance 27 is “L” and the capacitance value of the variable capacitance 28 is “C”, the impedance depends on LC. Thus, by adjusting the value of the variable inductance 27 and the value of the variable capacitance 28, the impedance value can be readily changed and the impedance value generated in the variable lumped constant unit 25 is readily adjusted. The variable inductance 27 and the variable capacitance 28 may be implemented using a control-type element or by way of switching of circuit connection. By providing an adjustment switch externally to the variable lumped constant unit 25, adjustment is readily made from outside.

This adjusts the electric distance as a sum of the impedance and the electric distance f the conductive line 24 to the quarter wavelength of a signal in use. It is thus possible to suppress variations in potential at the grounding end.

In this way, by connecting a combination of the variable lumped constant unit 25 and the conductive line 24 to the extremity of the grounding end 23, it is possible to flexibly reduce variations in potential in a much smaller circuit compared with the use of the conductive line 24 alone, while allowing the electric distance to be readily changed.

While the discussed variable lumped constant unit 25 is a circuit where the variable inductance 27 and the variable capacitance 28 are connected in parallel, either the inductance or capacitance may be a variable element, or any other circuit may be used. A necessary resistor element may be added to set a lumped constant.

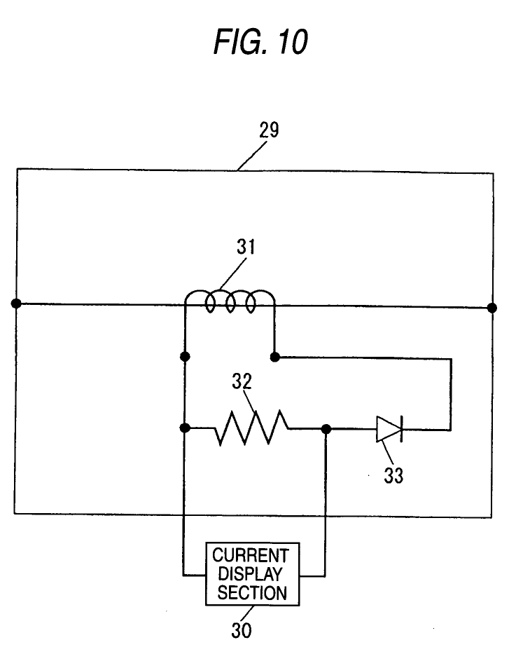

As shown in FIG. 9, a current measurement section 29 and a current display section 30 may be connected to each other in order to facilitate adjustment of a lumped constant of the variable lumped constant unit 25.

The current measurement section 29 measures a current value at the grounding end 23. The current display section 30 displays the result of measurement by the current measurement section 29. The fact that variations in potential at the grounding end 23 are the minimum means that the current at the grounding end 23 is the maximum (the voltage is the minimum). Thu, in order to adjust the lumped constant and set the lumped constant to the quarter wavelength of a signal which uses the electric distance from the grounding end 23 and the open end, it suffices to adjust the current value measured by the current measurement section 29 so that the value will be the maximum while checking the value on the current display section 30. By connecting the current measurement section 29 and the current display section 30 it is possible to implement the variable lumped constant unit 25 with a high-quality user interface, and accordingly, the radio communications medium processing unit 20 which features high accuracy and easy adjustment.

FIG. 10 shows an example of the circuit of the current measurement section 29.

The loop conductor 31 (spiral conductor) is penetrated by the line connecting the grounding end 23 and the variable lumped constant unit 25. To both ends of the loop conductor 31 are connected a resistor 32 and a diode 33. The current value is obtained from the ratio of the induced voltage generated on the loop conductor 31 to the resistor 32 and the current value is displayed on the current display section 30. The volume switch of the variable lumped constant unit may be adjusted so that the displayed current value will be the maximum.

While the current measurement section 29 and the current display section 30 are separately connected in FIG. 9, they may be built into the same unit or may be housed in the same unit or enclosure as the variable lumped constant unit 25. Further, they may be incorporated in the same unit or enclosure as the read/write section 22. It is preferable to incorporate all these sections in the same unit or enclosure to adjust the lumped constant while checking the current value on the display section arranged on the same unit. It is also preferable to provide and distribute the read/write section 22, the antenna 21, the variable lumped constant unit 25, the conductive line 24, the current measurement section 29 and the current display section 30 respectively in separate units for assembling the radio communications medium processing unit 20 in accordance with the installation location. This adds to the user-friendliness.

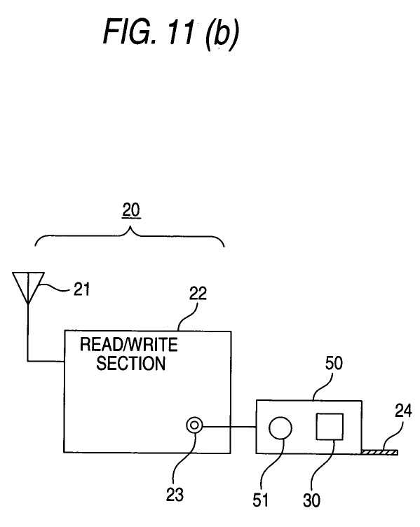

FIG. 11 shows a case where the lumped constant of the variable lumped constant unit 25 is automatically adjusted in accordance with the result obtained from the current measurement section 29.

The result from the current measurement section 29 is displayed on the current display section 30. The user adjusts the switch on the variable lumped constant unit 25 based on the displayed result to set a lumped constant. In case the unit is installed in a location where setting is difficult, automatic adjustment is preferable. It is thus preferable to use a lumped constant adjustment section 34 to adjust the variable lumped constant of the variable lumped constant unit 25 in accordance with the measured current value. The lumped constant adjustment section 34 is connected between the current measurement section 29 and the variable lumped constant unit 25 and receives the output of the current measurement section 29 and outputs an adjustment signal. For example, set values such as current values and variable inductance in the variable lumped constant unit 25 are tabulated previously and adjustment is made based on the table. In adjustment, mechanical adjustment using a mechanically operating volume switch is allowed. Or, an electric signal is supplied to an electrically operating volume control.

Specific configurations are shown in FIGS. 11B and 11C. FIG. 11B shows a radio communications medium processing unit to which is externally connected an adjustment unit 50 where an adjustment switch 51 and a current display section 30 are used to adjust the lumped constant. In the adjustment unit connected to the grounding end are installed a variable lumped constant unit 13 including a variable resistor, a variable inductance and a variable capacitance, and a current measurement section 29. A conductive line 24 is connected to the adjustment unit 50 externally, as shown in FIG. 11B. The conductive line 24 may be incorporated in the unit.

The current display section 30 displays the measurement result of the installed current measurement section. The adjustment switch 51 may be a manually operated volume switch or rotary switch, or a switch which automatically operates in coordination with a numeral from the current measurement section 29. In the case of a manual switch, the adjustment switch 51 may be adjusted so that the measurement current value displayed on the current display section 30 will be “0”, thereby reducing variations in potential at the grounding end. In the case of an automatic switch, the adjustment switch 51 operates in coordination so that the measurement current value from the current measurement section 29 will be “0”, thereby reducing variations in potential at the grounding end. For automatic operation, for example, an electric signal which cooperates with the operation of an ammeter is output to the adjustment switch 51, which operates in accordance with the electric signal. The adjustment switch is automatically controlled so that the measurement current value will be “0”, thereby reducing variations in potential at the grounding end.

FIG. 11C shows a case where the adjustment unit 50 is installed in the read/write section 22. The adjustment unit 50 may be mounted on the surface of the enclosure of the read/write section 22 or may be incorporated therein and at least the adjustment switch 51, or additionally the current display section 30 may be mounted on the surface of the enclosure. The conductive line 24 may be incorporated or externally provided.

The adjustment unit shown in FIG. 11C allows, same as the case in FIG. 11B, variations in potential at the grounding end by manually adjusting the mechanical volume switch or rotary switch while checking the current value shown on the current display section 30. Or, the adjustment switch automatically operates in accordance with a signal current corresponding to the measurement value from the current measurement section 29, thereby reducing variations in potential.

The adjustment switch may be toggled between manual and automatic modes. In the case of the automatic switch, the adjustment switch may be incorporated and need not appear on the surface of the enclosure. The adjustment switch may be a volume switch, a rotary switch, a DIP switch, a button switch, or a digital switch.

By automating the adjustment of a lump constant, it is possible to suppress variations in potential without the human intervention.

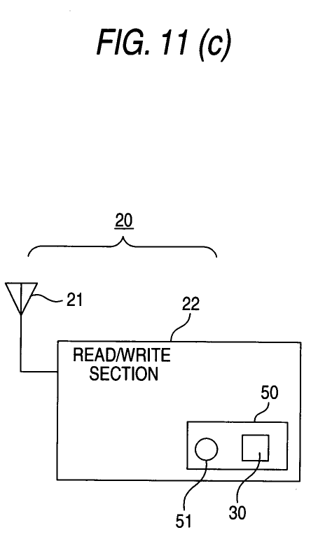

The grounding end 23 is present on both the read/write section and the antenna 21. As shown in FIG. 12, it is preferable to connect the conductive line 24 and/or variable lumped constant unit 25 to the grounding end 26 of the antenna 21.

In this case, the conductive line 24 and/or variable lumped constant unit 25 may be connected to both the grounding end 26 of the antenna 21 and the grounding end 23 of the read/write section 22, or to either of them. Only the conductive line having the quarter wavelength of a signal in use may be connected. The variable lumped constant unit 25 is preferably shared.

In case a plurality of grounding ends are present on the read/write section 22, the grounding ends may be aggregated and the variable lumped constant unit 25 and the conductive line 24 may be connected thereto. Or, the grounding ends may be individually connected as required.

The aforementioned radio communications medium processing unit can be used in various frequency bands. The radio communications medium processing unit is applicable to a frequency of about 13.56 MHz used for communications specified by ISO15693, because of a long wavelength. The radio communications medium processing unit is applicable and is effectively used in different frequency bands specified by other standards.

As mentioned hereinabove, by connecting the conductive line 24 having an electric distance equal to the quarter wavelength of a signal in use and the variable lumped constant unit 25 in combination with the conductive line 24 to the extremity of the grounding ends 23 and/or 26, it is possible to suppress variations in potential at the grounding ends 23; 26 and remarkably reduce determination errors in signal processing, providing a high-accuracy radio communications medium processing unit.

### Embodiment 3

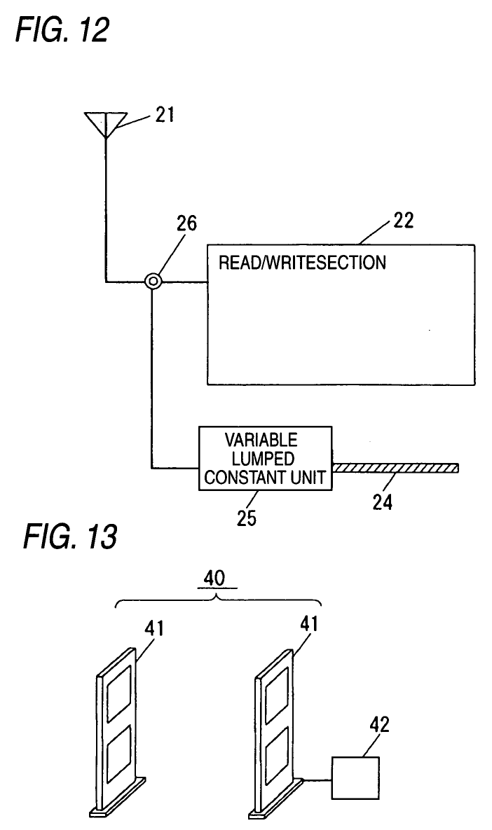

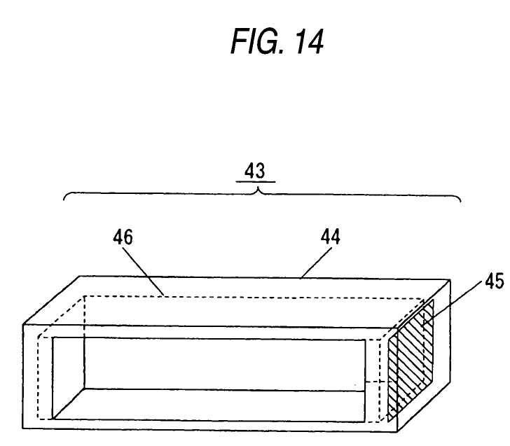

FIGS. 13 and 14 are perspective views of a radio communications medium processing unit according to Embodiment 3 of the invention.

FIG. 13 shows a case where the radio communications medium processing unit is incorporated in a gate unit. FIG. 14 shows a case where the radio communications medium processing unit is incorporated in a shelf-type box.

A numeral 40 represents a gate unit, 41 a gate antenna, 42 a radio communications medium processing unit, 43 a shelf unit, 44 a box, 45 a radio communications medium processing unit, and 46 a loop antenna.

The gate unit 40 is used for security in an airport and prevention of shoplifting in a bookstore. A magnetic field is generated between antennas by way of the gate antennas 41, thus allowing communications with a radio communications medium between the gate antennas 41. The radio communications medium processing unit 42 is connected to or incorporated into the gate antenna 41 and supplies power to a radio communications medium, writes/reads and analyzes data via the gate antenna. In this case, to the extremity of a grounding end on the radio communications medium processing unit 42 and the gate antenna 41 are connected a conductive line and a variable lumped constant unit described in Embodiment 1 and Embodiment 2. The electric distance from a grounding end to an open end may be set to the quarter wavelength of a signal in use. This makes it possible to suppress variations in potential at the grounding end, thereby remarkably reducing determination errors in signal processing. By incorporating a conductive line and a variable lumped constant unit into the gate antenna 41, downsizing of the unit is made possible.

By incorporating a radio communications medium processing unit which suppresses variations in potential at the grounding end into such a gate unit 40, it is possible to perform accurate processing as well as attaining security in the airport and prevention of shoplifting in a store.

The radio communications medium processing unit is preferably incorporated into a shelf unit.

By incorporating the loop antenna 46 and the radio communications medium processing unit 45 into the box 44, communications with the radio communications medium inside the box 44 is available. The loon antenna 46 can apply a magnetic field in all directions of the three dimension space. This allows communications irrespective of the position and orientation of the radio communications medium. On the radio communications medium processing unit 45, a conductive line and a variable lumped constant unit are connected to the grounding end as mentioned in Embodiments 1 and 2. This suppresses variations in potential and remarkably reduces determination errors in signal processing. As a result, it is possible to provide a high-accuracy shelf-type radio communications medium processing unit.

With such a high-accuracy shelf-type radio communications medium processing unit, communications with a commodity to which an IC tag is attached and which is placed in the internal space of the box 44, thus allowing automated commodity management. This type of commodity management is advantageous in that it is free from reduction in reliability due to determination errors in signal processing. The invention which suppresses variation in potential at the grounding end is highly effective and promises accurate and reliable automatic management of commodities. It is preferable to arrange a plurality of boxes 44 to expand the commodity management. It is also preferable to process the boxes 44 individually and transfer data on all the boxes to a server.

A unit other than the gate and shelf units, such as a cage unit, provides the same advantage.

As mentioned hereinabove, by connecting a conductive line and a variable lumped constant unit whose electric distance is the quarter wavelength to the extremity of a grounding end, it is possible to suppress variations in potential and enhance the accuracy of signal processing, thereby providing a radio communications medium processing unit which is accurate and reliable and suited for a variety of applications.

The radio communications medium processing unit of the invention comprises an antenna, a read/write section for reading or writing data, or reading and writing data from/to a radio communications medium via the antenna, and potential variation absorption means for absorbing variations in potential at the grounding end of the read/write section. With this configuration, the radio communications medium processing unit may be used in an application where it is necessary to perform accurate signal processing while eliminating variations in potential at the grounding end thereby suppressing variations in the ground potential transmitted from the grounding end into the unit.

This application is based upon and claims the benefit of priority of Japanese Patent Application No2003-392237 filed on Mar. 11, 1921, the contents of which are incorporated herein by references in its entirety.

1. A radio communications medium processing unit comprising:
an antenna;
a read/write section, reading or writing data, or reading and writing data from/to a radio communications medium via the antenna; and
a variable lumped constant unit or an electronic circuit, connected to either the read/write section or a grounding end provided at the antenna;
wherein the variable lumped constant unit or the electronic circuit absorbs variations in potential at the grounding end.

2. The radio communications medium processing unit according to claim 1 wherein the electronic circuit is an electronic circuit which adds a potential variation value at the grounding end so as to perform signal processing.

3. The radio communications medium processing unit according to claim 2, wherein the electronic circuit includes a Schmitt element.

4. The radio communications medium processing unit according to claim 2, wherein the electronic circuit includes a conditional reversal element which compares an arbitrary voltage value and a ground potential value at the grounding end and that the output of the conditional reversal element is used for signal processing by the electronic circuit.

5. The radio communications medium processing unit according to claim 1, wherein a conductive line whose length is below the quarter wavelength of the frequency in use is connected to the variable lumped constant unit and the extremity of the conductive line is open.

6. The radio communications medium processing unit according to claim 5, wherein the conductive line is flexible.

7. The radio communications medium processing unit according to claim 5, wherein the variable lumped constant unit is connected between the grounding end and the conductive line.

8. The radio communications medium processing unit according to claim 1, wherein the variable lumped constant unit is a variable resistor, or a variable inductance, or a variable capacitance, or a combination of these.

9. The radio communications medium processing unit according to claim 8, wherein:
the variable inductance is connected to the grounding end in series;
the variable capacitance is connected to the variable inductance in parallel;
a conductive line whose length is below the quarter wavelength of the frequency in use is connected to the variable inductance in series; and
the extremity of the conductive line is open.

10. The radio communications medium processing unit according to claim 1, wherein a current measurement section is connected between the variable lumped constant unit and the grounding end.

11. The radio communications medium processing unit according to claim 10, wherein the current measurement section includes a spiral conductor penetrated by a conductive line and a resistor and a diode connected between both terminals of the spiral conductor.

12. The radio communications medium processing unit according to claim 10, wherein a current display section is provided on the current measurement section.

13. The radio communications medium processing unit according to claim 10, wherein a lumped constant adjustment section for adjusting the lumped constant of the variable lumped constant unit in accordance with the output of the current measurement section is connected.

14. The radio communications medium processing unit according to claim 13, wherein the lumped constant adjustment section is a volume switch or a rotary switch or a DIP switch connected to the current measurement section and the variable lumped constant unit.

15. The radio communications medium processing unit according to claim 11, wherein the frequency in use is about 13.56 MHz.

16. A radio communications medium processing unit comprising:
an antenna; a read/write section, reading or writing data, or reading and writing data from/to a radio communications medium via the antenna; and
a variable lumped constant unit or an electronic circuit, connected to either the read/write section or a grounding end provided at the antenna;
wherein the variable lumped constant unit or the electronic circuit absorbs variations in potential at the grounding end; and
the radio communications medium processing unit is contained in a housing.

17. The radio communications medium processing unit according to claim 16, wherein at least part of the housing is shielded.

18. The radio communications medium processing unit according to claim 16, wherein:
a variable inductance is serially connected to the grounding end in series;
a variable capacitance is connected to the variable inductance in parallel;
a conductive line below the quarter wavelength of the frequency in use is serially connected to the variable inductance in series;
the extremity of the conductive line is open.

19. The radio communications medium processing unit according to claim 18, wherein all components except the conductive line are contained in the housing.

20. The radio communications medium processing unit according to claim 16, wherein at least either a current display section or a lump constant adjustment section is mounted on the surface of the housing.
